(19) United States
(12) Patent Application Publication
(10) Pub. No.: US 2017/0214994 A1
(43) Pub. Date: Jul. 27, 2017

(54) Earbud Control Using Proximity Detection

(71) Applicant: Knowles Electronics, LLC, Itasca, IL (US)

(72) Inventors: Sharon Gadonniex, Arlington, MA (US); Sarmad Qutub, Des Plaines, IL (US); William Ryan, Villa Park, IL (US)

(21) Appl. No.: 15/005,951

(22) Filed: Jan. 25, 2016

(51) Int. Cl. H04R 1/10; H04R 29/00; G01H 7/00

(52) U.S. Cl. CPC H04R 1/1016; G01H 7/00; H04R 29/001; H04R 1/105; H04R 1/1091; H04R 2420/07; H04R 2460/01; H04R 2201/003; H04R 2460/15

(57) ABSTRACT

Systems and methods for earbud control based on proximity detection are provided. An example method includes transmitting ultrasonic signals and receiving reflected ultrasonic signals. Based at least partially on the reflected ultrasonic signals, a distance of an earbud to an ear canal may be determined. If the distance is above a first predetermined threshold value, a low-power mode is activated. If the distance is below the first predetermined threshold value, a functionality of the earbud is modified. Modifying the functionality of the earbud may include activating a full power mode and may further include determining a quality of a seal, provided by the earbud, in the ear canal. If the quality of the seal is above a second predetermined threshold value, a positive feedback is provided to a user. If the quality of the seal is below the second predetermined threshold value, a negative feedback is provided to the user.

### FIELD

The present application relates generally to earbud control and, more particularly, to systems and methods for earbud control using proximity detection.

### BACKGROUND

Users of electronics are often concerned with extending and saving the battery life of their devices. In some cases, users may turn off their device to save battery life. Other common solutions to extending and saving battery life include providing devices with a sleep mode or hibernation mode to conserve battery. However, especially for earpiece-based audio devices, the known methods of battery conservation are typically limited to conscious user input and control.

### SUMMARY

Systems and methods for providing earbud control using proximity detection are provided. In various embodiments, insertion or removal of an earbud from an ear canal may be determined using proximity detection. An example method includes transmitting ultrasonic signals and receiving reflected ultrasonic signals. The example method further includes determining, based at least partially on the reflected ultrasonic signals, a distance of an earbud to an ear canal. If the distance of the earbud to the ear canal is above a first predetermined threshold value, the example method may proceed with activating a low-power mode of operation. For example, when it is determined that the earbud is removed from the ear canal, the earbud is automatically switched to a low-power mode of operation. When it is determined that the earbud is inserted into the ear canal, the earbud is automatically switched to a full power mode of operation.

In certain embodiments, if the distance of the earbud to the ear canal is below the first predetermined threshold value, the example method modifies a functionality of the earbud which may include determining a quality of a seal between the earbud and the ear canal. If the quality of the seal is good (e.g., above a predetermined threshold), the earbud may send the user a positive feedback, otherwise, the earbud may send the user a negative feedback and may then suggest a correction to the seal.

### BRIEF DESCRIPTION OF THE DRAWINGS

FIG. 1 is a block diagram of a system and an environment in which the system is used, according to an example embodiment.

FIG. 2 is a block diagram of a headset suitable for implementing the present technology, according to an example embodiment.

FIG. 3 is a block diagram illustrating a system for controlling power based on proximity detection, according to an example embodiment.

FIG. 4 is a block diagram of an exemplary acoustic apparatus with an ultrasonic detector, according to an example embodiment.

FIG. 5 is a flow chart showing steps of a method for earbud control based on proximity detection, including seal quality determination, according to various example embodiments.

FIG. 6 is a flow chart showing steps of a method for earbud control based on proximity detection, according to an example embodiment.

FIG. 7 illustrates an example of a computer system that may be used to implement embodiments of the disclosed technology.

### DETAILED DESCRIPTION

The present technology provides systems and methods for earbud control based on proximity detection, which can overcome or substantially alleviate problems associated with power consumption and seal quality. Embodiments of the present technology may be practiced on any earpiece-based audio device that is configured to receive and/or provide audio such as, but not limited to, cellular phones, MP3 players, phone handsets and headsets. While some embodiments of the present technology are described in reference to operation of a cellular phone or mobile device, the present technology may be practiced on any audio device.

In various embodiments, the earbud includes controls for power conservation. When a user removes an earbud from his or her ear, or is otherwise not wearing the earbud, power consumption of the earbud should be minimized. According to an example embodiment, a method for controlling an earbud includes transmitting ultrasonic signals, receiving reflected ultrasonic signals, and determining, based at least partially on the reflected ultrasonic signals, a distance of an earbud to an ear canal. If the distance of the earbud to the ear canal is above a first predetermined threshold value, a low-power mode of operation is activated. In further embodiments, if the distance of the earbud to the ear canal is below the first predetermined threshold value, a functionality of the earbud is adapted. The modifying the functionality of the earbud may include activating a full power mode of operation.

In some embodiments, the modifying the functionality of the earbud includes determining a quality of a seal, provided by the ear bud, in the ear canal. If the quality of the seal is above a second predetermined threshold value, the user is provided with a positive feedback. If the quality of the seal is below the second predetermined threshold value, the user is provided with a negative feedback. The positive feedback and the negative feedback may be audible feedback. For example, the positive feedback includes a first tone and the negative feedback includes a second tone. In other embodiments, the negative feedback includes a verbal instruction, which, for example, is an instruction to re-insert the earbud into the ear canal.

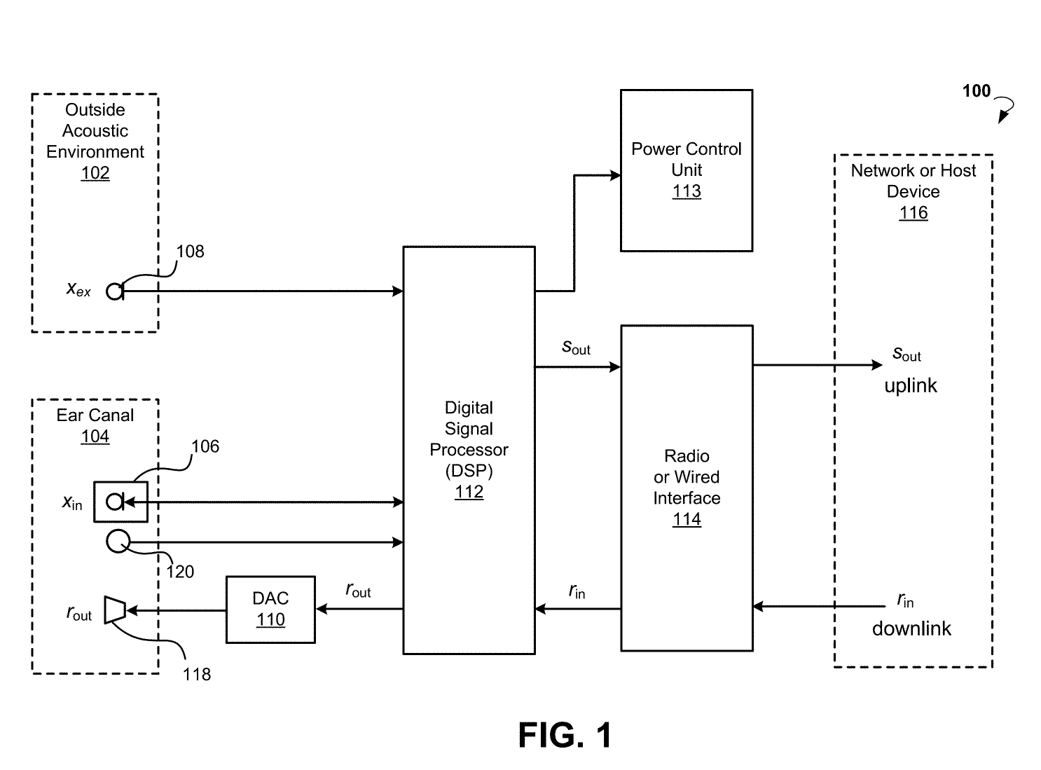

Referring now to FIG. 1, a block diagram of an example system 100 suitable for earbud control of an earbud and environment thereof are shown. The example system 100 includes at least an internal microphone 106, an external microphone 108, a digital signal processor (DSP) 112, and a radio or wired interface 114. The internal microphone 106 is located inside a user's ear canal 104 and is relatively shielded from the outside acoustic environment 102. The external microphone 108 is located outside of the user's ear canal 104 and is exposed to the outside acoustic environment 102. In some embodiments, the example system 100 includes an accelerometer 120. The accelerometer 120 is located inside a user's ear canal 104.

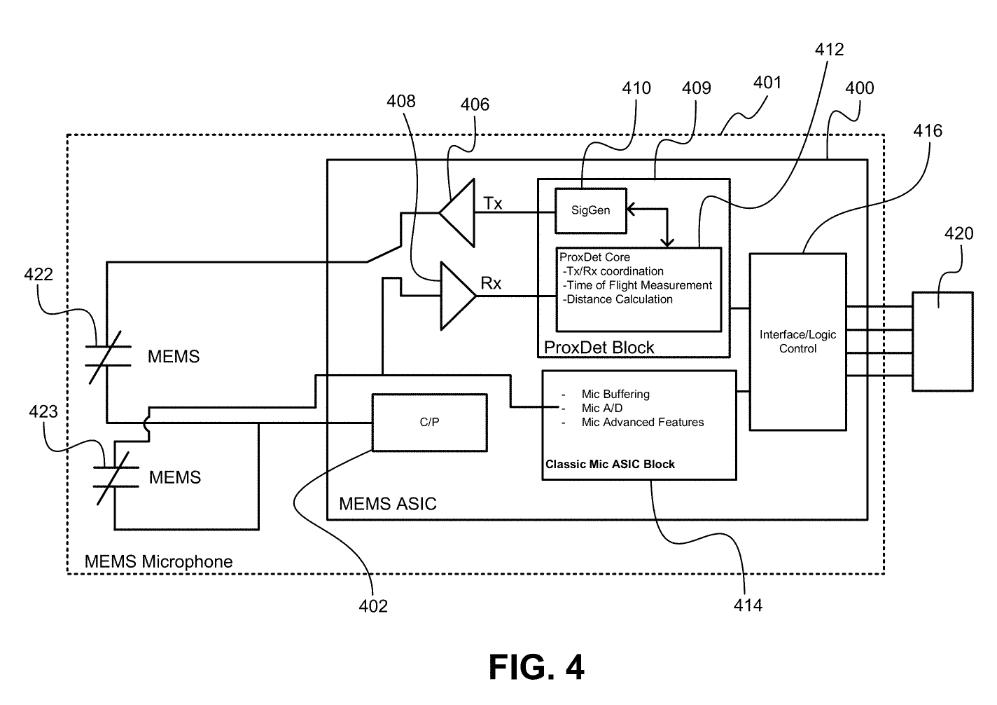

In various embodiments, the microphones 106 and 108 are either analog or digital. In either case, the outputs from the microphones are converted into synchronized pulse code modulation (PCM) format at a suitable sampling frequency and connected to the input port of the DSP 112. The signals xᵢₙ and xₑₓ denote signals representing sounds captured by internal microphone 106 and external microphone 108, respectively. In certain embodiments, internal microphone 106 is a proximity detection module, for example a dual microelectromechanical system (MEMS) microphone, as shown and described in FIG. 4. In other embodiments, the proximity detection module is provided separate from the internal microphone 106, wherein both the internal microphone 106 and the proximity detection module connect to the DSP 112.

The DSP 112 performs appropriate signal processing tasks to improve the quality of microphone signals xᵢₙ and xₑₓ. The output of DSP 112, referred to as the send-out signal (sₒᵤₜ), is transmitted to the desired destination, for example, to a network or host device 116 (see signal identified as sₒᵤₜ uplink), through a wireless or wired interface 114.

If a two-way voice communication is needed, a signal is received by the network or host device 116 from a suitable source (e.g., via the radio or wired interface 114). This is referred to as the receive-in signal (rᵢₙ) (identified as rᵢₙ downlink at the network or host device 116). The receive-in signal can be coupled via the radio or wired interface 114 to the DSP 112 for processing. The resulting signal, referred to as the receive-out signal (rout), is converted into an analog signal through a digital-to-analog convertor (DAC) 110 and then connected to a loudspeaker 118 in order to be presented to the user. In some embodiments, the loudspeaker 118 is located in the same ear canal 104 as the internal microphone 106. In other embodiments, the loudspeaker 118 is located in the ear canal opposite the ear canal 104. In example of FIG. 1, the loudspeaker 118 is found in the same ear canal 104 as the internal microphone 106; therefore, an acoustic echo canceller (AEC) may be needed to prevent the feedback of the received signal to the other end. Optionally, in some embodiments, if no further processing of the received signal is necessary, the receive-in signal (rᵢₙ) can be coupled to the loudspeaker without going through the DSP 112. In some embodiments, the receive-in signal rᵢₙ includes an audio content (for example, music) presented to a user.

In additional embodiments, FIG. 1 includes a power control unit 113. Power control unit 113 may be controllable manually by a user and automatically by the system (e.g., DSP 112 executing the method of the present disclosure) to activate a full power mode of operation or a low-power mode of operation for the example system 100. In the low-power mode of operation, one or more internal components of the earbud may be turned off or otherwise deactivated to save power while maintaining minimal functionality, such as proximity detection. The system can detect the proximity of the earbud to the ear canal while in the low-power mode of operation. As such, if the system determines that the earbud has been inserted into the ear canal by the proximity detection, it will switch from the low-power mode of operation to a full (normal) power mode of operation. In other embodiments, the low-power mode of operation may include an off or no power state, which requires a manual button press or other suitable user input to turn on.

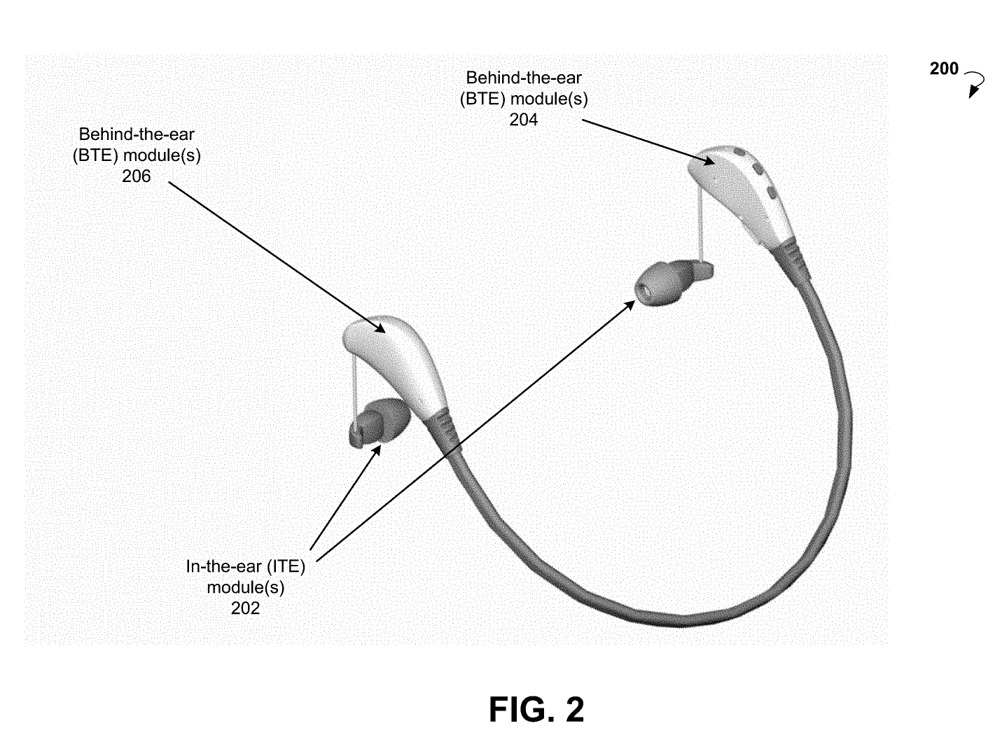

FIG. 2 shows an example headset 200 suitable for implementing methods of the present disclosure. The headset 200 includes example in-the-ear (ITE) module(s) 202 and behind-the-ear (BTE) modules 204 and 206 for each ear of a user. The ITE module(s) 202 are configured to be inserted into the user's ear canals. The BTE modules 204 and 206 are configured to be placed behind (or otherwise near) the user's ears. In some embodiments, the headset 200 communicates with host devices through a wireless radio link. The wireless radio link may conform to a Bluetooth Low Energy (BLE), other Bluetooth, 802.11, or other suitable wireless standard and may be variously encrypted for privacy. The example headset 200 is a non-limiting example and other variations having just an in-the-ear “earpiece” may also be used to practice the present technology.

In various embodiments, ITE module(s) 202 include internal microphone(s) 106 and loudspeaker (s) 118 (shown in FIG. 1), all facing inward with respect to the ear canal 104. The ITE module(s) 202 can provide acoustic isolation between the ear canal(s) 104 and the outside acoustic environment 102. In some embodiments, ITE module(s) 202 include at least one accelerometer 120 (shown in FIG. 1).

In some embodiments, each of the BTE modules 204 and 206 includes at least one external microphone 108 (shown in FIG. 1). The BTE module 204 may include a DSP 112 (as shown in FIG. 1), control button(s), and wireless radio link to host devices. In certain embodiments, the BTE module 206 includes a suitable battery with charging circuitry.

In some embodiments, the seal of the ITE module(s) 202 is good enough to isolate acoustics waves coming from outside acoustic environment 102. However, when speaking or singing, a user can hear the user's own voice reflected by ITE module(s) 202 back into the corresponding ear canal. The sound of the voice of the user is distorted since, while traveling through the user's skull, the high frequencies of the voice are substantially attenuated and thus have a much narrower effective bandwidth compared to voice conducted through air. As a result, the user can hear mostly the low frequencies of the voice. The user's voice cannot be heard by the user outside of the earpieces since the ITE module(s) 202 isolate external sound waves, particularly when a quality of a seal of the earpiece and the ear canal is good.

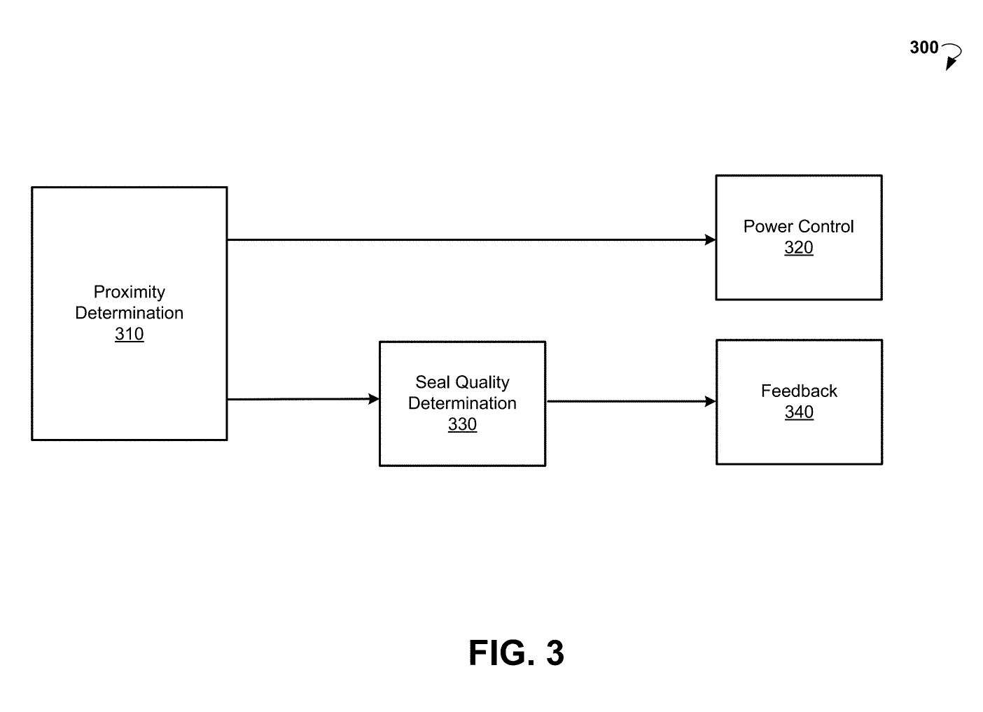

FIG. 3 is a block diagram showing an example system 300 for earbud control based on proximity detection, according to an example embodiment. The example system 300 includes proximity determination module 310, power control module 320, seal quality determination module 330, and feedback module 340. The modules 310-340 of example system 300 can be implemented as instructions stored in a memory and executed by at least one processor, for example DSP 112. In certain embodiments, at least some of the instructions performing the functionalities of the modules 310-340 are stored in a memory and executed by at least one processor of the network or host device 116.

In various embodiments, the proximity determination module 310 is operable to determine a distance between an earbud and the user's ear canal.

A non-limiting example for proximity detection utilizing a dual-purpose ultrasonic MEMS microphone or transducer is shown and described in FIG. 4, and in commonly assigned U.S. patent application Ser. No. 14/872,887, filed Oct. 1, 2015, entitled “Acoustic Apparatus with Dual MEMS Devices,” which is hereby incorporated by reference herein in its entirety.

Other exemplary embodiments utilizing a dual-purpose ultrasonic MEMS microphone having a proximity determination module 310 may also use an infrared sensor, or other suitable sensor for determining a distance parameter between the earbud and an object.

In certain embodiments, the proximity determination module 310 is configured to transmit ultrasonic signals, receive reflected ultrasonic signals, and calculate the distance to the object or portion of the user's head. In one example, the proximity determination module 310 calculates the distance with a pseudo noise correlation sequence by observing a correlation factor of a pseudo random signal. The pseudo noise correlation sequence is particularly robust in an environment with ambient interference. In other examples, the proximity determination module 310 calculates the distance by measuring a time-of-flight or amplitude of the reflected ultrasonic signals.

In some embodiments, the power on/off control module 320 is provided to switch the earbud from a full (normal) power mode of operation to a low power mode of operation, to conserve battery life when the user is not using the earbud. In certain embodiments, the power control module 320 switches the earbud on and off.

In further embodiments, the seal quality determination module 330 is operable to receive at least internal microphone signal xᵢₙ and external microphone signal xₑₓ and determine the quality of seal of an ear canal. For example, the quality of seal can be determined based on a difference between signal xᵢₙ and signal xₑₓ. If signal xᵢₙ includes components similar to components of signal xₑₓ, it indicates that outside noise is heard inside the earbud, reflective of a bad seal quality. The components may include noise components, voice components, power present in frequency bands, or other suitable components of signal xᵢₙ and signal xₑₓ. The difference between signals may also represent a cross-correlation between the internal microphone signal xᵢₙ and the external microphone signal xₑₓ. An example system suitable for determining seal quality is discussed in more detail in U.S. patent application Ser. No. 14/985,187, entitled “Audio Monitoring and Adaptation Using Headset Microphones Inside User's Ear Canal,” filed on Dec. 30, 2015, and U.S. patent application Ser. No. 14/985,057, entitled “Occlusion Reduction and Active Noise Reduction Based on Seal Quality,” filed on Dec. 30, 2015, the disclosures of which are incorporated herein by reference for all purposes.

FIG. 4 is a block diagram of an exemplary acoustic apparatus with an ultrasonic detector. A MEMS dual-purpose application specific integrated circuit (ASIC) 400 includes a charge pump 402, an amplifier 406, a buffer 408, a proximity detection block or module 409 (including a signal generator 410 and a proximity detection core 412), and a buffering module 414, and an interface logic control module 416. The ASIC 400 is coupled to a system controller 420 and a first MEMS transducer 422 and a second MEMS transducer 423 (or any other type of transducer such as a piezoelectric transducer, to give one example). It will be appreciated that if a piezoelectric sensor is used, the charge pump 402 is not needed. The system controller 420 may also be external to the ASIC 400.

In various embodiments, the first MEMS transducer 422 is configured to transmit ultrasonic signals. The first MEMS transducer 422 (or the second MEMS transducer 423) is configured to detect the reflection of the ultrasonic signals. The second MEMS transducer also receives audible acoustic signals and converts the audible acoustic signals to electrical signals.

The MEMS transducers 422 and 423, and the ASIC 400 may be incorporated into a MEMS microphone 401. In these regards, the ASIC 400 and MEMS transducers 422 and 423 may be disposed on a base and covered by a lid or cover. The lid, cover, or base may have a port allowing sound and reflected sound to enter the microphone, and allow ultrasonic signals to exit the MEMS microphone 401.

The proximity detection block or module 409 may be any combination of hardware and/or software configured to perform proximity detection. Ultrasonic signals are transmitted, reflected ultrasonic signals are received from an object of interest, and the proximity (e.g., distance) is calculated to the object of interest.

In some embodiments, the proximity detection core 412 makes a time-of-flight measurement. The proximity detection core 412 calculates the time-of-flight from the time the ultrasonic signal is transmitted until the time the reflected ultrasonic signal is received. In another embodiment, the proximity detection core 412 determines proximity by measuring an amplitude of the reflected ultrasonic signal, or otherwise measuring a signal amplitude parameter. In a further embodiment, the proximity detection core 412 compares the reflected signal to a pseudo random signal, for example by a cross-correlation or sliding inner product, and calculates a correlative factor to determine proximity.

In certain embodiments, the MEMS microphone 401 arrangement in FIG. 4 is the internal microphone 106 (shown in the example in FIG. 1 and described above) in order to provide the internal microphone with the various proximity detection functionality. In other embodiments, the MEMS microphone 401 is provided in addition to the internal microphone 106.

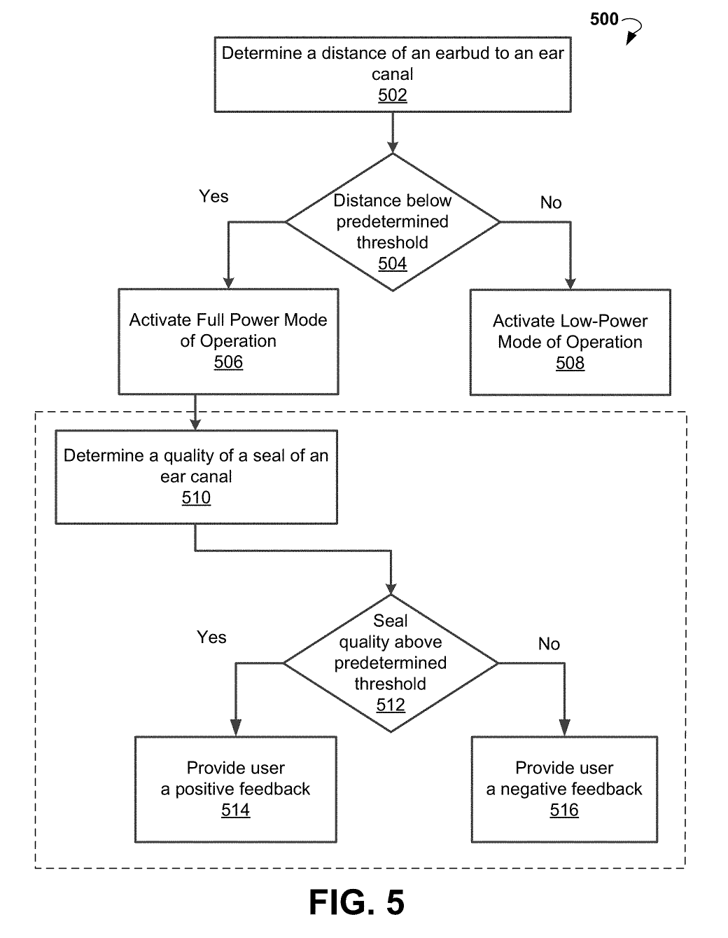

FIG. 5 is a flow chart showing steps of an example method 500 for earbud control based on proximity detection, including seal quality determination, according to various example embodiments. The example method 500 can commence with determining a distance of an earbud to an ear canal in block 502. In determination block 504, a determination is made based on whether the distance between the earbud and the ear canal is below a first predetermined threshold value. If the distance is below the first predetermined threshold value, example method 500 can proceed with activating (switching to) a full (normal) power mode of operation. The distance being below the predetermined threshold value may be indicative of the user inserting the earbud into his or her ear canal. If the distance is above the first predetermined threshold value, example method 500 can proceed with activating (switching to) a low-power mode of operation, in block 508. The distance being above the predetermined threshold value may be indicative of the user removing the earbud from his or her ear canal.

In certain embodiments, example method 500 includes additional, optional steps if the distance is below the first predetermined threshold value. For example, in block 510, a quality of a seal of an ear canal is determined. Seal quality is detected after determining that the user has inserted the earbud into his or her ear canal. As a result, power is saved by performing seal quality detection when a good seal is preferable (e.g., when the earbud is in use). In some embodiments, the quality of the seal can be determined based on a difference between signal xₑₓ captured by the external microphone 108 and signal xᵢₙ captured by the internal microphone 106. If signal xᵢₙ includes components similar to components of signal xₑₓ, it indicates that outside noise is captured by the internal microphone (e.g., in the ITE module) inside the ear canal. The components may include noise components, voice components, power present in frequency bands, or other suitable components to determine the quality of the seal. The difference between signals may also represent a cross-correlation between the internal microphone signal xᵢₙ and the external microphone signal xₑₓ.

In decision block 512, a determination is made based on the quality of the seal of the ear canal. If the quality of the seal is above a predetermined threshold value, example method 500, in this example, proceeds with providing the user a positive feedback 514. Alternatively, if the quality of the seal is below a predetermined threshold value, then example method 500, in this example, proceeds with providing the user a negative feedback 516. In some embodiments, the positive and negative feedback are audible feedback, and includes having a first and a second tone, respectively. In other embodiments, the negative feedback includes a verbal warning or instruction directing the user to re-adjust or re-insert the earbud into their ear canal.

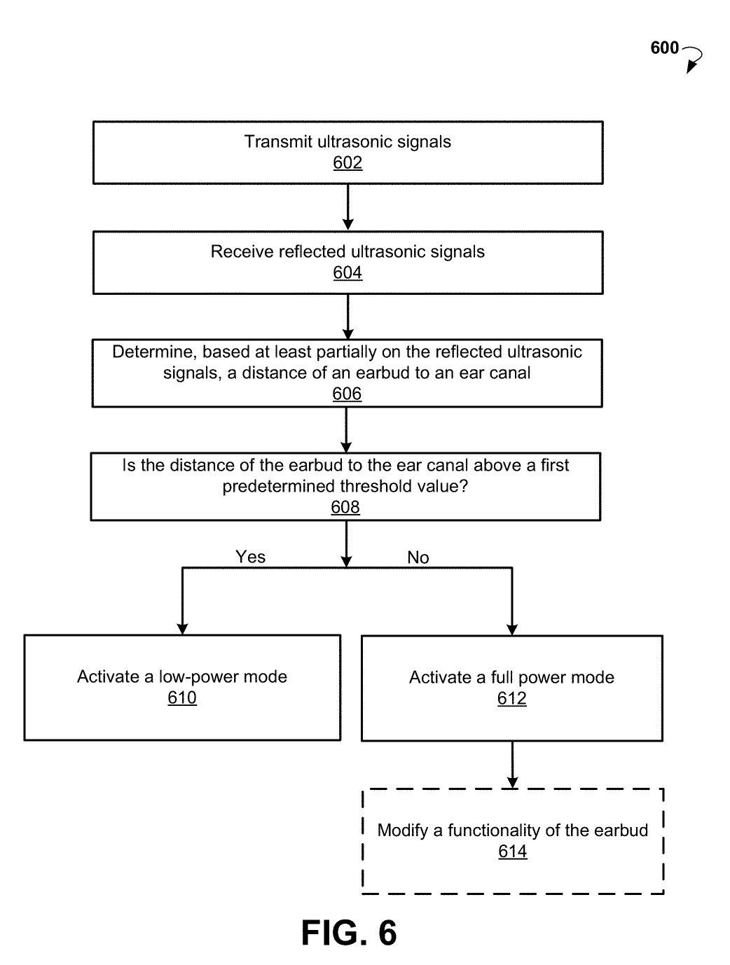

FIG. 6 is a flow chart showing steps of a method 600 for earbud control based on proximity detection, according to various example embodiments. The example method 600 can commence with transmitting one or more ultrasonic signals in block 602. The ultrasonic signals may be transmitted by a dual-purpose ultrasonic MEMS microphone or transducer. In block 604, one or more reflected ultrasonic signals are received, the ultrasonic signals reflecting off of an object of interest (e.g., the ear canal) as the reflected ultrasonic signals.

In block 606, based at least partially on the reflected ultrasonic signals, a distance of an earbud to an ear canal is determined. For example, the proximity detection module makes a time-of-flight measurement by calculating duration between the time the ultrasonic signal is transmitted and the time the reflected ultrasonic signal is received. In another example, the proximity detection module determines the first distance parameter by measuring the amplitude of the reflected ultrasonic signal.

In block 608, the method 600 proceeds with determining if the distance of the earbud to the ear canal is below a first predetermined threshold value. If the distance is above the first predetermined threshold, a low-power mode is activated 610. Alternatively, if the distance is below the first predetermined threshold value, a full power mode is activated 612. Optionally, a functionality of the earbud may be modified in block 614. For example, block 614 may perform steps 510-516 as shown in FIG. 5.

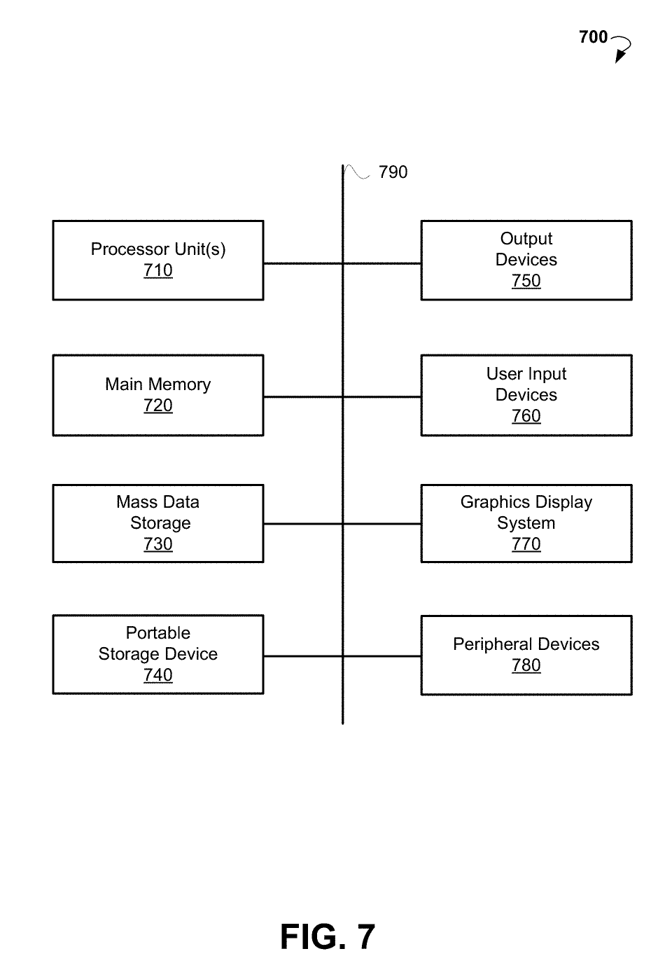

FIG. 7 illustrates an exemplary computer system 700 that may be used to implement some embodiments of the present invention. The computer system 700 of FIG. 7 may be implemented in the contexts of the likes of computing systems, networks, servers, or combinations thereof. The computer system 700 of FIG. 7 includes one or more processor unit(s) 710 and main memory 720. Main memory 720 stores, in part, instructions and data for execution by processor unit(s) 710. Main memory 720 stores the executable code when in operation, in this example. The computer system 700 of FIG. 7 further includes a mass data storage 730, portable storage device 740, output devices 750, user input devices 760, a graphics display system 770, and peripheral devices 780.

The components shown in FIG. 7 are depicted as being connected via a single bus 790. The components may be connected through one or more data transport means. Processor unit(s) 710 and main memory 720 is connected via a local microprocessor bus, and the mass data storage 730, peripheral device(s) 780, portable storage device 740, and graphics display system 770 are connected via one or more input/output (I/O) buses.

Mass data storage 730, which can be implemented with a magnetic disk drive, solid state drive, or an optical disk drive, is a non-volatile storage device for storing data and instructions for use by processor unit(s) 710. Mass data storage 730 stores the system software for implementing embodiments of the present disclosure for purposes of loading that software into main memory 720.

Portable storage device 740 operates in conjunction with a portable non-volatile storage medium, such as a flash drive, floppy disk, compact disk, digital video disc, or Universal Serial Bus (USB) storage device, to input and output data and code to and from the computer system 700 of FIG. 7. The system software for implementing embodiments of the present disclosure is stored on such a portable medium and input to the computer system 700 via the portable storage device 740.

User input devices 760 can provide a portion of a user interface. User input devices 760 may include one or more microphones, an alphanumeric keypad, such as a keyboard, for inputting alphanumeric and other information, or a pointing device, such as a mouse, a trackball, stylus, or cursor direction keys. User input devices 760 can also include a touchscreen. Additionally, the computer system 700 as shown in FIG. 7 includes output devices 750. Suitable output devices 750 include speakers, printers, network interfaces, and monitors.

Graphics display system 770 include a liquid crystal display (LCD) or other suitable display device. Graphics display system 770 is configurable to receive textual and graphical information and processes the information for output to the display device.

Peripheral devices 780 may include any type of computer support device to add additional functionality to the computer system.

The components provided in the computer system 700 of FIG. 7 are those typically found in computer systems that may be suitable for use with embodiments of the present disclosure and are intended to represent a broad category of such computer components that are well known in the art. Thus, the computer system 700 of FIG. 7 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, TIZEN, and other suitable operating systems.

The processing for various embodiments may be implemented in software that is cloud-based. In some embodiments, the computer system 700 is implemented as a cloud-based computing environment, such as a virtual machine operating within a computing cloud. In other embodiments, the computer system 700 may itself include a cloud-based computing environment, where the functionalities of the computer system 700 are executed in a distributed fashion. Thus, the computer system 700, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 700, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for controlling an earbud, the method comprising:
transmitting ultrasonic signals;
receiving reflected ultrasonic signals;
determining, based at least partially on the reflected ultrasonic signals, a distance of an earbud to an ear canal; and
if the distance of the earbud to the ear canal is above a first predetermined threshold value, activating a low-power mode of operation.

2. The method of claim 1, wherein the earbud further comprises an ultrasonic microelectromechanical system (MEMS) microphone for the transmitting of the ultrasonic signals and the receiving of the reflected ultrasonic signals.

3. The method of claim 2, wherein activating the low-power mode of operation includes deactivating one or more internal components of the earbud, other than the ultrasonic MEMS microphone.

4. The method of claim 2, wherein the ultrasonic MEMS microphone comprises a transceiver for the ultrasonic signals.

5. The method of claim 1, further comprising, if the distance of the earbud to the ear canal is below the first predetermined threshold value, modifying a functionality of the earbud.

6. The method of claim 5, wherein the modifying the functionality of the earbud includes activating a full power mode of operation.

7. The method of claim 6, wherein the modifying the functionality of the earbud further comprises:
determining a quality of a seal, provided by the earbud, of the ear canal; and
if the quality of the seal is below a second predetermined threshold value, providing the user with a negative feedback.

8. The method of claim 7, wherein the determining the quality of the seal comprises comparing at least one component of a first acoustic signal captured outside the ear canal and at least one component of a second acoustic signal captured inside the ear canal, wherein the determination of the quality of the seal is based on a difference between the at least one component of the first acoustic signal and the at least one component of the second acoustic signal.

9. The method of claim 8, wherein the earbud further comprises an ultrasonic microelectromechanical system (MEMS) microphone for the transmitting of the ultrasonic signals and the receiving of the reflected ultrasonic signals, wherein the ultrasonic MEMS microphone captures the second acoustic signal.

10. The method of claim 8, wherein an internal microphone of the earbud captures the second acoustic signal.

11. The method of claim 7, further comprising, if the quality of the seal is above the second predetermined threshold value, providing the user with a positive feedback.

12. The method of claim 11, wherein the positive feedback and the negative feedback are audible feedback.

13. The method of claim 12, wherein the positive feedback includes a first tone and the negative feedback includes a second tone.

14. The method of claim 7, wherein the negative feedback includes an instruction to re-insert the earbud into the ear canal.

15. The method of claim 7, wherein the negative feedback includes a verbal instruction.

16. The method of claim 1, wherein the determination of the distance of the earbud to the ear canal is based at least in part on a time-of-flight calculation, a signal amplitude calculation, or a pseudo noise correlation sequence.

17. A system for controlling an earbud, the system comprising:
at least one processor; and
a memory communicatively coupled with the at least one processor, the memory storing instructions, which, when executed by the at least one processor, perform a method comprising:
transmitting ultrasonic signals;
receiving reflected ultrasonic signals;
determining, based at least partially on the reflected ultrasonic signals, a distance of an earbud to an ear canal; and
if the distance of the earbud to the ear canal is above a first predetermined threshold value, activating a low-power mode of operation.

18. The system of claim 17, wherein the earbud further comprises an ultrasonic microelectromechanical system (MEMS) microphone for the transmitting of the ultrasonic signals and the receiving of the reflected ultrasonic signals.

19. The system of claim 18, wherein activating the low-power mode of operation includes deactivating one or more internal components of the earbud, other than the ultrasonic MEMS microphone.

20. The system of claim 18, wherein the ultrasonic MEMS microphone comprises a transceiver for the ultrasonic signals.

21. The system of claim 17, further comprising, if the distance of the earbud to the ear canal is below the first predetermined threshold value, modifying a functionality of the earbud.

22. The system of claim 21, wherein the modifying the functionality of the earbud includes activating a full power mode of operation.

23. The system of claim 22, wherein the modifying the functionality of the earbud further comprises:
determining a quality of a seal, provided by the earbud, of the ear canal; and
if the quality of the seal is below a second predetermined threshold value, providing the user with a negative feedback.

24. The system of claim 23, wherein the determining the quality of the seal further comprises comparing at least one component of a first acoustic signal captured outside the ear canal and at least one component of a second acoustic signal captured inside the ear canal, wherein the determination of the quality of the seal is based on a difference between the at least one component of first acoustic signal and the at least one component of the second acoustic signal.

25. The system of claim 24, wherein the earbud further comprises an ultrasonic microelectromechanical system (MEMS) microphone for transmitting the ultrasonic signals and receiving the reflected ultrasonic signals, wherein the ultrasonic MEMS microphone captures the second acoustic signal.

26. The system of claim 24, wherein an internal microphone of the earbud captures the second acoustic signal.

27. The system of claim 23, further comprising, if the quality of the seal is above the second predetermined threshold value, providing the user with a positive feedback.

28. The system of claim 27, wherein the positive feedback and the negative feedback are audible feedback.

29. The system of claim 28, wherein the positive feedback includes a first tone and the negative feedback includes a second tone.

30. The system of claim 23, wherein the negative feedback includes a verbal instruction.

31. The system of claim 17, wherein the determination of the distance of the earbud to the ear canal is based at least in part on a time-of-flight calculation, a signal amplitude calculation, or a pseudo noise correlation sequence.

32. A non-transitory computer readable storage medium having embodied thereon instructions, which, when executed by the at least one processor, perform steps of a method, the method comprising:
transmitting ultrasonic signals;
receiving reflected ultrasonic signals;
determining, based at least partially on the reflected ultrasonic signals, a distance of an earbud to an ear canal; and
if the distance of the earbud to the ear canal is above a first predetermined threshold value, activating a low-power mode of operation.
